(19) United States
(12) Patent Application Publication
(10) Pub. No.: US 2024/0367073 A1
(43) Pub. Date: Nov. 7, 2024

(54) SYSTEM FOR CLARIFYING PROCESS WATER IN OIL AND GAS OPERATIONS

(71) Applicant: Redhawk Coil Tubing, Kilgore, TX (US)

(72) Inventors: Waylin Bruce Ott, Gladewater, TX (US); Jerry Wayne Noles, Blanchard, OK (US); Stephen Greak, Kilgore, TX (US)

(73) Assignee: Redhawk Coil Tubing, Kilgore, TX (US)

(21) Appl. No.: 18/650,623

(22) Filed: Apr. 30, 2024

Related U.S. Application Data
(60) Provisional application No. 63/463,246, filed on May 1, 2023.

(51) Int. Cl. B01D 21/08; B01D 21/00; B01D 21/01; B01D 21/24; C02F 1/00; C02F 1/24; C02F 1/52; C02F 1/72; C02F 103/10

(52) U.S. Cl. CPC B01D 21/08; B01D 21/0042; B01D 21/0084; B01D 21/01; B01D 21/2438; C02F 1/24; C02F 1/5281; C02F 1/72; C02F 2001/007; C02F 2103/10; C02F 2301/046

(57) ABSTRACT

A portable unit and associated processing are described for clarifying process water used in oil and gas operations such as fracking or drill-out operations. In the portable unit, dirty water (402) is introduced into a clarifier (400). The dirty water (402) is directed to a bottom of the clarifier (400) where dissolved air 408 from a dissolved air flotation pump (410) is injected into the water (402). The water (402) then passes across the inclined plates (412). Particles are separated from the water (402) via interaction with the plates (412) and directed to collectors (414), at the bottom of the clarifier (404), by gravitation. In addition, a floc, enhanced by the injection of the dissolved air (408), is skimmed from the water surface. The result of this process flow is clarified water (430) that can be returned to the frack and post-frack completion process.

### CROSS-REFERENCE TO RELATED APPLICATION

This application claims priority to U.S. Provisional Patent Application No. 63/463,246 entitled “System for Clarifying Process Water in Oil and Gas Operations,” filed May 1, 2023, the contents of which are incorporated herein as if set forth in full and priority is claimed to the full extent allowable under U.S. law and regulations.

### FIELD OF THE INVENTION

The present invention relates generally to clarifying water used in an oil and gas operation and, in particular, to a mobile water clarification unit and associated processing for clarifying and recycling water used in fracking and post fracking completion operation.

### BACKGROUND OF THE INVENTION

Certain operations in the oil and gas field use significant volumes of process water. The case of hydraulic fracturing and associated completion operations including drill-out and clean out (“fracking operations”) are illustrative. In fracking operations, water is pumped at high pressure into a subterranean formation to expand cracks or fissures thereby enhancing recovery of residual oil and gas. During completion and post hydraulic fracturing processes, water may be pumped into formations to remove zonal isolation plugs used during fracking operations or to ensure that the wellbore is clear of contaminants and ready for production.

More specifically, during the completion of an oil and gas well, especially horizontal wells requiring hydraulic fracturing, sufficient fluid, sand, and pressure is pumped into the well to separate or fracture the rock while the sand props the fracture open providing a path for migration of the oil and gas. In the case of horizontal wells, the long length of the lateral is typically broken into shorter intervals starting with what is referred to as the toe of the well. Explosive charges are used to penetrate the steel well casing and external cement thereby providing a connection to the reservoir. The water, sand, and chemicals are then injected into these perforations until a desired volume is achieved. This is referred to as a stage and is of shorter length than the entire casing allowing the hydraulic fluid pressure to be more precisely concentrated on smaller areas. Once this is completed a plug is set to isolate that area and the process is repeated. This isolation and fracturing continue until the entire horizontal section or lateral length is completely fractured.

The process water used in these operations may be obtained from local sources, such as rivers or lakes, and is typically trucked to the fracking site. The water may then be passed through a sand filter to remove coarse particles and enhance pump operation. Used water is recovered from the formation and, in some cases, may be passed through a sand filter and reused in one or more additional fracking cycles. However, reuse of the water, when it is possible at all, is limited as particles accumulated during fracking and post frac completions build-up and limit the rates that can be achieved by the pumps and, thereby, the effectiveness of the operation. Therefore, the operator soon needs to dispose of the water. This typically involves trucking the water to a disposal site where the water may be pumped into a subterranean storage reservoir that is safe from surface water contamination.

In recent years, operators have focused considerable attention on the water used in fracking and completion operations. This attention has been spurred by government regulations and public scrutiny as well as the expense and difficulty of handling large volumes of water at well sites. These factors relate to both the volume of water used and safe storage of used water. The completion or zonal plug isolation removal referred to as drill-out operations may take from one day to a week or more and, in conventional operations, may require over one-quarter of a million barrels of water per day. It will be appreciated that reducing the volume of water used in such operations would reduce consumption of a sometimes-scarce resource, reduce concerns about safe storage of used water, and reduce the costs, as well as simplify the logistics, of fracking operations.

### SUMMARY OF THE INVENTION

The present invention is directed to a portable unit and associated processing (“system”) for clarifying process water used in oil and gas operations such as fracking or drill-out operations. The system can be used for clarifying water from a surface or other source before use in fracking or completion operations and/or for clarifying water recovered from a fracking or completion process for reuse in a further cycle of the operation. Optionally, water may also be clarified after a final use and before storage in a subterranean or other reservoir. In this manner, water usage is reduced, storage concerns are reduced, the effectiveness of fracking operations is enhanced, costs are reduced, and logistics are simplified, among other advantages.

The present inventors have recognized that conventional sand filters used in fracking operations limit the effectiveness of fracking pumps and limit the ability to reuse process water in the fracking or completion operations. Such sand filters are effective at removing coarse particles but sub-micron particles build-up in water. This build-up can quickly diminish the effectiveness of the pump rates resulting in increased pump pressure and reduced pump rates if the water is repeatedly reused.

Conventional technologies for removing submicron particles are problematic in certain oil and gas contexts. One such technology involves polymer membranes or ceramic filters. The polymeric membranes are typically made from a PVFD material. However, oil and gas operations may require many of these filters. Oil and gas operations generally produce some oil during the completion phase. The PVFD materials may wick the oil into the membrane causing it to quickly become clogged and rendered unusable. Ceramic filters are generally effective in removing the oil from the water but may become clogged by particles such as iron and clays in the water. Many of the particles typically found in the process water are silica, clay, and iron and ceramic membranes, therefore, are generally unsuitable.

Particle removal is further complicated by production of natural gas in the fracking operations. For example, the drill-out or cleanout process is done underbalanced or with a fluid having a hydrostatic pressure or combined hydrostatic pressure and surface pressure that is lower than the producing hydrocarbon reservoir thereby allowing a certain amount of gas to enter the fluid during the operation. This gas can either be what is considered sweet gas, such as methane, or it can be sour gas such as hydrogen sulfide, a very poisonous and corrosive gas. This gas can be dissolved in the water and, if left in, can break-out of the water during reuse as the water is pressurized and agitated by the pumps. Once liberated through this agitation, this gas can result in damage to the carbon steel of the pipe and down hole casing. In a closed loop system such as used during the drill-out phase, The resulting submicron particles continue to build-up with each cycle into and out of the well until the chemicals that are added to the water to help reduce the circulating pressure and remove the contaminants from the well no longer work. However, if these particles could be removed from the water, then the water could be reused during the entire operation and a storage volume of a few thousand gallons could be continuously recirculated instead of pumping it through the system once or twice and disposing of millions of gallons of water. Therefore, a need to remove these submicron particles exists. The present invention allows the water to be reused for multiple applications or throughout the entire completion process.

In accordance with one aspect of the present invention, a crossflow clarifier is used to treat process water in an oil and gas industry application. The inventive system involves providing a clarifier in a flow path of the process water. The clarifier includes at least one inclined plate having a top end, a bottom end, and first and second side ends. The clarifier is oriented such that a first axis of the plate, extending between the top and bottom ends thereof, is inclined relative to horizontal. Preferably, the first axis is oriented at an angle between about 30-90 degrees relative to horizontal, for example, about 60 degrees. The system further involves flowing the process water on the flow path such that the process water flows across the plate along a second axis transverse to the first axis. For example, the second axis may extend across the plate between the first and second sides thereof.

The clarifier may be used to clarify source water introduced into a fracking operation, to clarify water recovered from a subterranean formation and reused in a fracking operation, and/or to clarify water at the end of a fracking operation and used during the drill-out phase or before the water is delivered into a storage reservoir. In this regard, the flow path may be a supply path for supplying a pump system for use in a fracking operation. Additionally or alternatively, the flow path may be a recirculation path for recirculating water from a subterranean formation for reuse in the fracking and drill-out operation. In the latter regard, the clarifier may be interposed between a recovery port, for recovering the process water from the subterranean formation, and an injection port for injecting the process water into the subterranean formation.

The clarifier is preferably operable to remove submicron particles from the process water and may involve gravitational separation and/or flotation processes. Gravitational separation may be executed by flowing the process water across the inclined plate such that gravity causes particles to be separated from the process water and accumulated at the bottom end of the inclined plate. In many cases, it is anticipated that clarification may be accomplished via gravitational separation and/or flotation without requiring any chemical treatment of the process water. However, the water may be processed in connection with the clarifier to accelerate gravitational separation and/or flotation. Such processing may involve the use of a coagulant, flocculants, and/or an oxidizer, among other possibilities.

Such processing may further involve use of dissolved air flotation. In addition, a skimmer may be employed to remove a product separated from the water via flotation. Such a skimmer may skim a surface of the water in the clarifier periodically or on an as-needed basis to remove oil and sludge. The use of dissolved air has proven effective in improving the ORP (oxidative redux potential) of the water as well. The oxidation can not only help to disassociate the solids and oil from the fluid but to help convert iron from soluble to insoluble while improving the chemical oxygen demand (COD) and biological oxygen demand (BOD). Oxidation processes have proven beneficial in reducing the bacteria and removing small trace amounts of H2S from the water as well. High-speed centrifuges that deliver G forces between 2,000 to 12,000 Gs may be used to remove and dewater the solids that accumulate in the skim and settling areas of the clarification unit as well. In one application the upper and lower boundary layers of the clarification tank are constantly skimmed and processed through a high-speed centrifuge allowing the dewatered solids to be discharged and the clarified water to be reintroduced back into the clarification tank. Using the centrifuge in conjunction with the clarification tank to process the upper and lower concentrates allows for higher overall process rates than what the centrifuge on its own could process and the maximum throughput of the clarification tank is not limited to the process rate of the centrifuge.

In accordance with another aspect of the present invention, a filtering system including coarse and fine filters is provided for use in a geologic process. The system involves obtaining water from a water source and operating a pump system to pump the water into a target subterranean formation. For example, the water source may be a surface source, such as a lake or river, or the water source may be water recovered from the subterranean formation and intended for reuse in the geologic process or disposal. The geologic process may be an operation of the oil and gas industry such as a fracking operation. The system further involves operating a filtering system, interposed between the water source and pump system, to remove contaminants from the water. The filtering system includes a first, coarse filter for removing coarse particles from the water and a second submicron filter for removing fine particles from the water. The coarse particles have a size of greater than one micron whereas the fine particles have a size of less than one micron. For example, the submicron filter system may comprise a crossflow clarifier as described above.

### BRIEF DESCRIPTION OF THE DRAWINGS

For a more complete understanding of the present invention and further advantages thereof, reference is now made to the following detailed description, taken in conjunction with the drawings, in which:

FIG. 1 illustrates a fracking operation in accordance with the present invention;

FIG. 2A illustrates a water clarification system that may be implemented in the fracking operation of FIG. 1;

FIGS. 2B-2C show top and side perspective views, respectively, of a crossflow water clarifier of the clarification system of FIG. 2A;

FIG. 3 illustrates a water clarification process of the fracking operation of FIG. 1;

FIG. 4 illustrates a process flow of a clarification system in accordance with the present invention;

FIG. 5 shows a perspective view of a plate that may be used in a crossflow water clarifier in accordance with the present invention.

### DETAILED DESCRIPTION

In the following description, the invention is set forth in the context of a portable, crossflow water clarifier system for clarifying process water used in a fracking and post-frack completion operation. Specific implementations are described that may include, for example, treatment of the water with various agents to enhance precipitation and gravitational separation of contaminants from the water as well as separation of contaminants from the water by flotation or the use of a centrifuge to increase the gravitational forces on the solids. It will be appreciated that the invention is not limited to such contexts or implementations. For example, addition of the precipitation and separation agents may not be required for some operations. Accordingly, the following description should be understood as illustrative and not by way of limitation.

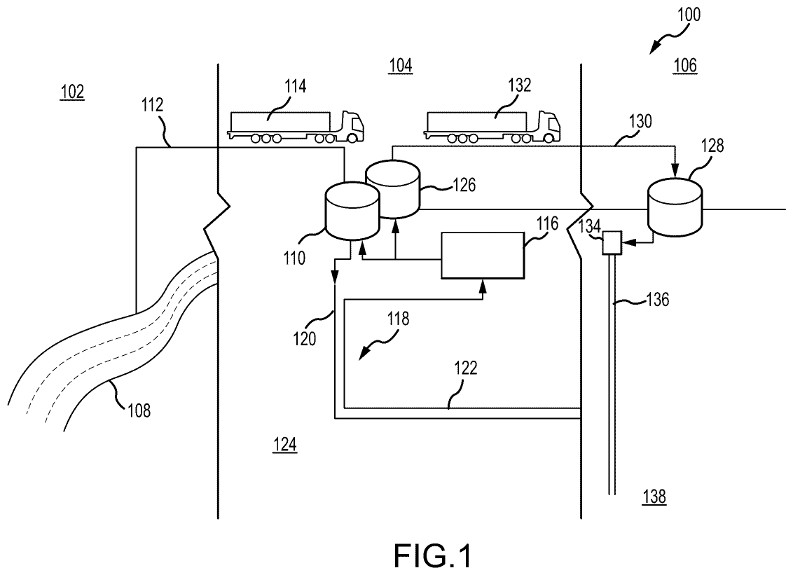

FIG. 1 illustrates a fracking operation 100 in accordance with the present invention. The operation 100 involves a water source site 102, a fracking site 104, and a disposal/storage site 106. Water for the fracking operation 100 is obtained from a water source 108 at the source site 102. For example, the water source 108 may be a surface water source such as a river or lake. It will be appreciated that, in some cases, the water from the source 108 may have high concentrations of particles such as clay, organic matter, waste products, and other solids. The water may be pumped from the source 108 into a transport vehicle 114, such as a truck, for transportation to the fracking site 104 via path 112. Alternatively, the water may be pumped to the fracking site 104 via a pipeline or otherwise transported to the site 104.

While conventional fracking operations and post-frack drill-outs generally require large volumes of water and considerable truck traffic, it will be appreciated that the fracking operation 100 in accordance with the present invention may use much less water. This may allow for use of different water sources 108, including local sources at the fracking site 104, such that transport vehicles 114 can be eliminated. In any case, the size and number of vehicles/trips can be substantially reduced. For example, practical fracking and post-frack drill-out operations in accordance with the present invention may use only thousands or even hundreds of gallons of water that can be transported in various types of tanks.

At the fracking site 104, the water may be transferred from the transport vehicle 114 to one or more storage tanks 110. As discussed below, the water may be pretreated prior to the fracking operation. The water is then pumped via a well 118 into a target subterranean formation 124 under pressure to enlarge cracks or fissures for enhanced oil and gas recovery. The well 118 may include a vertical or substantially vertical portion 120, extending from the surface to the formation 124, and a horizontal or substantially horizontal portion 122 extending laterally within the formation to increase the effective fracking interface.

During the fracking operation, water is also recovered from the formation 124 via the well 118 or a separate well for treatment by a crossflow clarifier 116 as will be described in more detail below. The clarified water may then be delivered to a storage tank 110, the same as or different than the tank where the source water was originally deposited, for reuse in a further cycle of the fracking or post-frack drill-out process. It is anticipated that the same process water may be used throughout a fracking and drill-out operation without the need to replace the water due to excessive contamination. Thus, the total volume of water used for an operation will be greatly reduced.

At the conclusion of a fracking operation, the process water may be deposited in a tank 126 that may be the same as or different than the tank 110. Optionally, the water may be processed by the clarifier 116 at the conclusion of the fracking operation prior to deposit in the tank 126. From the tank 126, the water may be transported to a disposal site 106 using a transport vehicle 132, such as a truck, via path 130. Again, the water may alternatively be pumped to the disposal site 106 via a pipeline or otherwise transported. It will be appreciated that the operation 100 of the present invention uses much less water than conventional operations. Therefore, the number and size of vehicles 132 as well as the number of trips will be greatly reduced. At the disposal site 106, the water is transferred from the vehicle 132 to a temporary storage tank 128. The water can then be pumped from the tank 128 into an underground storage reservoir 138 via a well 136 using a pump system 134. In one implementation, a clarification system may be provided at the disposal site to remove solids from the water and to prevent plugging of the subterranean formation into which the water is being disposed or stored.

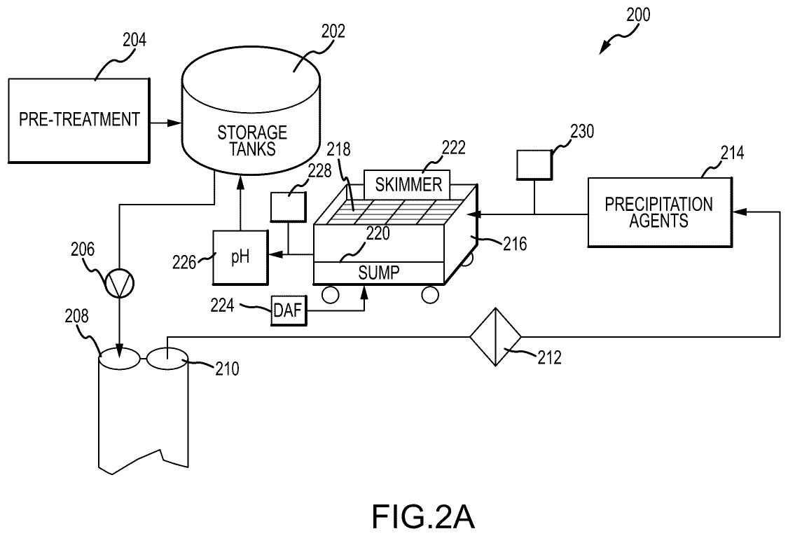

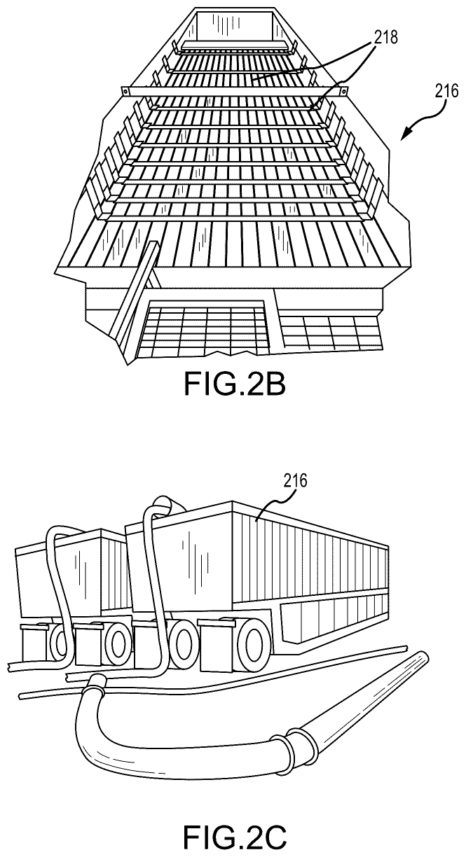

FIGS. 2A-2C illustrate a water clarification system 200 in accordance with the present invention. The illustrated system 200 may correspond to the system 116 depicted in FIG. 1. As described above, water from a water source may be deposited in one or more storage tanks 202. One or more pretreatment agents 204 may be added to the water in the tank 202 or at another location. For example, a biocide, corrosion inhibitor, and/or an H2S scavenger may be added to the water and uniformly mixed before it is pumped to the well. In addition, a proppant, such as sand or a synthetic material, may be added to the water to hold cracks or fissures open after hydraulic fracturing, and/or a friction reducer, such as anionic polyacrylamide, may be added to reduce the circulating pressure required from the pumping system. Water is pumped, by pump 206, from the storage tank 202 into a well via an inlet port 208. As noted above, the well is used to deliver the water to the target subterranean formation for the fracking process. Water from the formation is recovered via an exit port 210 of the well or a separate well. Another pump may be used to pump the water from the formation, or the water may flow to the port 210 due to the pressure of the system.

The effluent water from the formation may then be passed through a sand filter 212 that is effective to remove coarse particles, e.g., particles having a size greater than one micron, for example, greater than 100 μm. From the filter 212 the water passes to a mixing station for adding one or more precipitation agents 214. As noted above, it is anticipated that adding precipitation agents 214 will not be required for all operations. That is, the crossflow clarifier may provide sufficient clarification without such agents. However, in the illustrated embodiment, precipitation agents are added prior to delivering the water to the crossflow clarifier 216. Such agents 214 may include one or more of a coagulant, a flocculant, and an oxidizer. A coagulant is a substance used to group particles together to thereby accelerate gravitational separation. Any suitable coagulant may be utilized. For example, aluminum sulfate, commonly referred to as alum, may be added to the process water. A flocculant is a material that is used as a clumping agent, for example, to promote production of a floc that can be removed from the water by flotation and skimming. Any suitable flocculant may be utilized. For example, an ionic polyacrylamide, commonly referred to in the oil and gas industry as a friction reducer or FR, may be added to the process water. An oxidizer is a material that introduces oxygen into the process water to enhance certain chemical reactions that may improve precipitation. For example, the oxidizer may react with iron-containing substances in the water to form compounds that are more readily removed from the water by gravitational separation or flotation.

The process water is then delivered to the crossflow clarifier 216. The clarifier 216 includes a number of inclined plates 218 that are angled relative to horizontal and thereby use Stokes law to aid in particle separation. As the water passes between the plates the dense particles gravitationally separate from the water and slide down the plates to a collection sump 220.

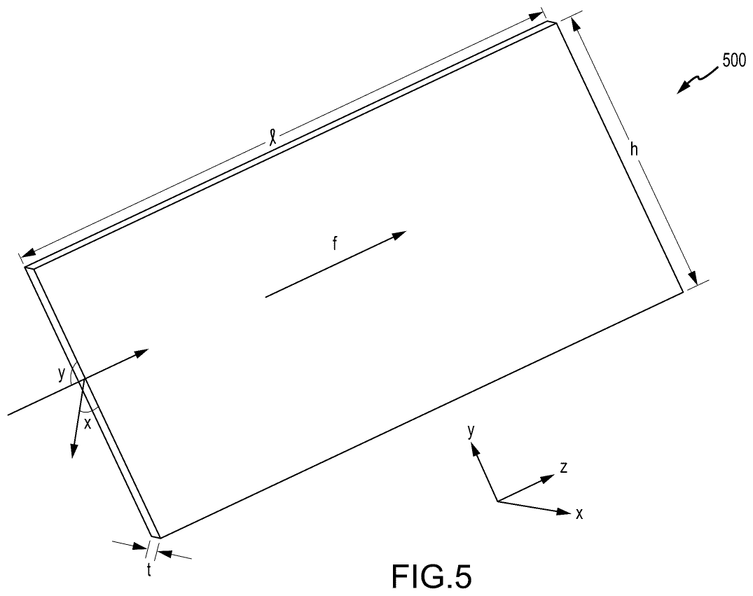

FIG. 5 shows a plate 500 that may be used in the clarifier 216 of FIG. 2. The illustrated clarifier 216 includes plates 500 that are vertical or set at an angle, y, relative to horizontal (corresponding to the x-z plane in the coordinate system of FIG. 5). The illustrated plate 500 is also set at an angle, x, relative to vertical. In this regard, the plates 500 may be set at an orientation relative to horizontal of between about 30-90 degrees, more preferably between about 45-75 degrees, for example, about 60 degrees.

The illustrated clarifier 216 may be a cross-flow clarifier where the process water flows across the inclined plates rather than up the incline of the plates. This is shown in FIG. 5 where the flow direction is indicated by the arrow labeled “f.” As shown, the water flows from side-to-side across the plate 500. This is distinguished from what may be called up-flow clarifiers where the water flows up the inclined face of a clarifier plate. While up-flow configurations may be used for some implementations in accordance with the present invention, the cross-flow configuration has been found to yield advantages for the present application. In particular, the longitudinal orientation of the plates generates less turbulence and allows longer contact time between the water and the plates, thereby facilitating gravitational separation of particles from the water. The contact time between the water and plate is not limited to the vertical height of the plate but rather the length of the plate or series of aligned plates. This can result in 3-4 times more contact time for given dimensions of the clarifier.

Moreover, in an up-flow configuration, the movement of the water can generate lift that counteracts the gravitational force used to remove particles from the water. This can cause smaller particles to travel with the fluid flow and avoid separation and capture by the clarifier. The cross-flow configuration also allows the plates to be closely spaced, thus increasing the surface area where particles can be separated from the flow. It will be appreciated that separation of particles is enhanced by providing areas that have a slow flow velocity or are shielded from the higher velocity flow areas of the water. Such slower flow velocities are provided at the surface of the plates. In addition, the plates can be configured to enhance separation. For example, the plates can be angled in relation to a vertical center plane of the clarifier, such that plates on opposite sides of the vertical center plane form a funnel that narrows towards the bottom of the clarifier. This configuration funnels particles towards a central collection repository and provides substantial plate surface area that is shielded from the higher velocity water flow.

In addition, slots and vertical separator plates may be provided along the water flow path in the clarifier 216. Vertical plates may be provided at the start (upstream) and end (downstream) sides of the clarifier 216, as well as between sections of the clarifier. For example, the clarifier may include several (e.g., 5 or more) sections of inclined plates arranged serially relative to the flow path. These vertical plates may have vertical slots formed therein to direct and maintain longitudinal flow of the water over the inclined plates. This also tends to slow the flow rate through the clarifier to enhance gravitational (and flotation) separation.

The plates may be formed from a variety of materials. In one embodiment, the plates are formed from a plastic or resinous material that is hydrophobic or has an affinity for oil. For example, the plates may be formed from polyvinylidene fluoride (PVDF). Such materials attract oil from the water and enhance agglomeration of fine oil droplets into larger droplets and gravitation.

In the illustrated embodiment, the plates 500 may be formed from sheets of PVDF having a thickness, t, of about ⅛-½ inch, for example, about ¼ inch. The sheets may have a length of between about 4-10 feet and a height, h, of between about 4-10 feet (the length and height need not be the same). For example, the plates may be about 8 feet by 8 feet. At least some of the sheets may be separated from adjacent sheets by a separation distance of about 1-2 inches and are arranged in a generally parallel configuration. The slots in the vertical plates may be about 6 inches high and about 7 feet long.

In addition to gravitational separation, the clarifier 216 uses a flotation process for water clarification. The flotation and oxidation process is enhanced by a dissolved air flotation unit 224 that injects dissolved air into the clarifier 216 to promote flotation and particle disassociation of solids and oil and to generate a floc on the surface of the water in the clarifier 216. This flotation product can then be removed by a skimmer 222. For example, the skimmer 222 may be an automatic system that periodically, or on an as-needed basis, passes a skimming attachment such as a solid paddle or fine screen across the surface of the water to remove the flotation product or floc. Alternatively, the skimmer 222 may continuously skim the floc. In any case, the floc may then be sent through a centrifuge for the dewatering of the solids and the clarification of the water, whereas the water is introduced back into the clarification tank. The clarified water from the clarifier 216 may then be delivered back to the storage tank 202 for treatment and reuse in subsequent cycles of the fracking or drill-out operation.

The system 200 may be monitored to ensure proper operation, for example, to optimize the addition of precipitation agents and the operating parameters of the dissolved air flotation unit 224. Various parameters may be monitored in this regard including the flow rate of the process water, the rate of addition of the separation agents, and properties of the water such as pH or chemical composition. For example, the aluminum sulfate used as a coagulant has a low pH. This low pH can be used as an indicator to determine the rate of addition of the aluminum sulfate. However, failure to fully satisfy the positive charge of the aluminum sulfate or balancing the charge on the influent side of the clarifier 216, when the same chemical is used for pressure reduction, can result in reducing the friction reducing polymer's performance on the effluent or downstream side.

Preferably, the system is operated at a steady state of flow as much as is practicable. When running at a substantially constant rate, the pH can be used as an indication of how much of the aluminum sulfate's charge is being satisfied. Satisfying the charge is accomplished when the negatively charged particles in the water are drawn to the positive charges of the aluminum sulfate. These particles coagulate with the aluminum sulfate and can be dropped or floated out of the water by the introduction of the anionic polyacrylamide polymer. This causes a floc to form as the polymer is drawn to any of the charge that may remain on the aluminum sulfate. However, failure to satisfy this charge fully will leave active positive charges in the water that is then circulated back to the chemical unit and fluid pump. This positive charge can then reduce the performance of the friction reducer thereby affecting the injection pressure during the drill-out and pumping operations. Adjustments of the pH downstream from the water clarification can help to satisfy and neutralize the positive charge from the aluminum sulfate. Accordingly, in the illustrated system 200, a pH rectification unit 226 is provided between the clarifier 216 and the storage tank 202. The unit 226 can add acidic or basic chemicals to the water as needed to maintain an optimal pH level. The unit can be operable manually or automatically to add the chemicals and can be operated responsive to sensors 228 and 230 upstream and/or downstream from the clarifier 216. In the illustrated embodiment, the sensors may be pH sensors but other sensors may be used to monitor other feedback parameters.

In one configuration, the operation is completely mechanical requiring no chemical addition to the water beyond the use of dissolved air to facilitate an oxidation process while causing flotation and particle disassociation of solids and oils from the water. The inclined plates accelerate larger particle separation and the centrifuge removes and dewaters the solids from the upper and lower boundary layers of the clarification tank. The solids are then discharged from the system for disposal while the clarified water from the high G force centrifuge is reintroduced back into the clarification tank. In this configuration the high-speed centrifuge that is used may have multi-phase separation and may be used to allow the water, oil, and solids to be directed to different collection points.

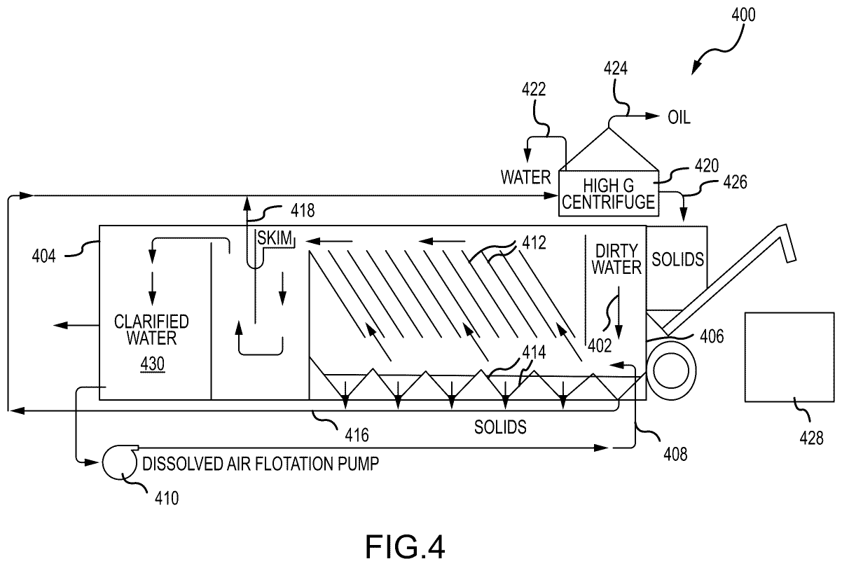

FIG. 4 illustrates a process flow for a clarification system 400 in accordance with the present invention. The clarification system 400 can be used in fracking and post frac completion operations as described above. In the illustrated embodiment, dirty water 402 is introduced into a clarifier 404 at an inlet end 406. The dirty water 402 is directed to a bottom of the clarifier 400 where dissolved air 408 from a dissolved air flotation pump 410 is injected into the water 402. The water 402 then passes up the inclined plates 412. In this case, the plates may be configured as an up-flow clarifier rather than a cross-flow clarifier as may be suitable for certain applications. Particles are separated from the water 402 via interaction with the plates 412 and directed to collectors 414, at the bottom of the clarifier 404, by gravitation. In addition, a floc, enhanced by the injection of the dissolved air 408, is skimmed from the water surface at the top of the clarifier 404. Solids 416 from the collectors 414 and floc 418 from the skimming process are delivered to a High G centrifuge 420. The centrifuge 420 separates water 422 and oil 424 from the solids. The solids 426 are then expelled to a repository 428 for disposal. The water 422 can be returned to the clarifier 404 and to the larger system. The oil 424 can be collected for further processing as desired. The result of this process flow is clarified water 430 that can be returned to the frack and post frac completion process. It will be appreciated that the components as described above, including the dissolved air flotation components, skimmer, solid collection components, centrifuge, and the like, can be implemented in cross-flow and up-flow configurations.

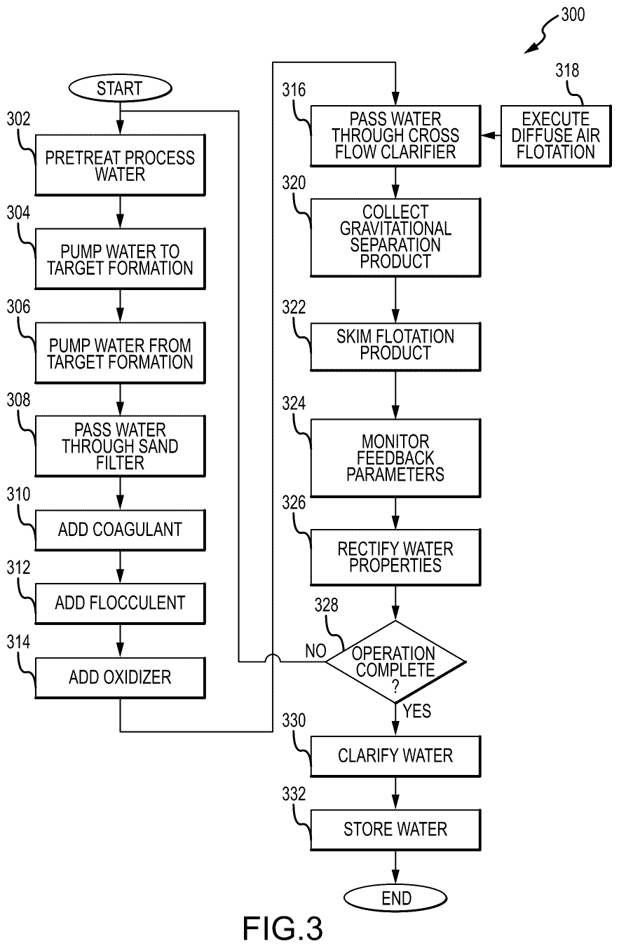

FIG. 3 is a flowchart illustrating a water clarification process 300 in accordance with the present invention. The process is initiated by pretreating (302) the process water. This may involve adding a friction reducer, proppants, and other additives to the water prior to initiation of or during a fracking operation. The water is then pumped (304) to a target formation for hydraulic fracturing, cleaning out, or other processes of a fracking operation. The water is then recovered (306) from the formation. It will be appreciated that the recovered water may include process chemicals as well as hydrocarbons and contaminants from the formation.

The recovered water is an initially passed (308) through a sand filter to remove coarse particles, e.g., particles having a size greater than 1 μm, for example greater than 100 μm. In some cases, it may be desired to then add agents to the water to facilitate gravitational separation and/or flotation in the clarifier. In this regard a coagulant may be added (310) to group particles together and thereby assist in gravitational separation. In addition, a flocculant may be added (312) to enhance clumping of particles. The flocculant in combination with diffuse air flotation can enhance production of a floc that can be skimmed from the clarifier water surface. An oxidizer may also be added (314) to produce chemical reactions to facilitate precipitation of certain contaminants such as iron-containing components.

After any such desired agents have been added, the water is passed (316) through the crossflow clarifier. As discussed above, the clarifier includes a number of inclined or vertical plates that assist in gravitational separation of the particles from the process water. In particular, such particles will slide down the plates to be collected (320) by a sump at the base of the clarifier unit that can be periodically cleaned out. In addition to gravitational separation, the clarifier may execute a flotation process. To assist in this process, diffuse air flotation may be executed (318). This may involve injecting diffuse air into the clarifier to promote flotation of a floc containing precipitated particles. The floc can then be skimmed (322) from the surface of the water in the clarifier. This may be executed by an automatic skimmer that skims the surface continuously, periodically, or as needed.

In conjunction with the clarification process 300, feedback parameters may be monitored (324). These feedback parameters may include flow rates, rates of introduction of various agents, measured properties of the water (e.g., pH at various locations, chemical levels detected by photometry or other sensors, and the like), pressure levels, or other process parameters. Based on the measured feedback parameters, the water properties may be rectified (326), e.g., to optimize clarification and/or fracking operation effectiveness. If the fracking operation is complete (328) the water may optionally be clarified (330) and transported to a disposal location for storage (332). Otherwise, the clarified water may be deposited in a storage tank for reuse in another cycle of the frack process.

The clarification system as described herein has a number of advantages. As discussed above, the system enables reuse of process water, thereby reducing the water requirements, reducing truck traffic, reducing water disposal, reducing environmental concerns, and reducing costs. In addition, the system reduces disposal costs and potential environmental impact. The water that is disposed of after a fracking operation, in addition to being reduced in volume, is much cleaner than water typically resulting from conventional fracking operations. Because dirty water from conventional fracking operations, which may be muddy and viscous, is difficult for commercial disposal facilities to process, such facilities may charge a significantly higher disposal fee for the same volume of clean water. For example, such fees may be as much as 4-5 times higher.

The system also removes particles and chemicals from the water that improves the performance, up-time, and longevity of equipment. As noted above, the system removes more particles and finer particles from the water that improves the efficiency of pumps and other equipment. This allows the equipment to execute fracking operations that are deeper or have longer laterals. Moreover, the removal of particles reduces the abrasion and associated corrosion of pipes, downhole equipment, and other materials. The result is that down time is reduced. All of this also allows fracking operations to be completed more quickly, further reducing expenses.

In addition, disposal of the solids resulting for the system as described herein is easier and less expensive. The use of the centrifuge and other components as described above results in a solid waste product that may be suitable for safe collection in an inexpensive disposal container for disposal in a landfill site, thereby substantially reducing disposal costs.

The system also enables recovery of oils from the water. The oils are recovered both by gravitation and flotation as described above. Such oils are more completely recovered than in conventional systems, yielding potentially significant improvements in efficiency as well as revenues.

The system also reduces the need for various additives, such as H2S scavengers and friction reducers, and removes more chemicals from the water. This results in both savings and reduced environmental concerns.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A method for use in connection with treating process water in an oil and gas industry application, comprising:
providing a clarifier in a flow path of said process water, said clarifier including at least one inclined plate having a top end, a bottom end, and first and second side ends;
disposing said clarifier such that a first axis of said at least one plate is inclined at an angle relative to horizontal; and
flowing said process water on said flow path such that said process water flows across said at least one plate along a second axis transverse to said first axis.

2. The method of claim 1, wherein said second axis extends across said at least one plate between said first and second sides thereof.

3. The method of claim 1, wherein said first axis extends across said plate between said top end and said bottom end thereof.

4. The method of claim 1, wherein said flow path is a supply path for supplying said process water to a pump system for use in a fracking operation.

5. The method of claim 4, wherein said flow path is configured for recirculating said process water recovered from a subterranean formation for reuse in said fracking operation.

6. The method of claim 5, wherein said clarifier is interposed between a recovery port, for recovering said process water from said subterranean formation and an injection port for injecting said process water into said subterranean formation.

7. The method of claim 1, wherein said clarifier is operative for removing particles from said process water via at least one of gravitational separation and flotation.

8. The method of claim 7, further comprising processing said process water to accelerate said at least one of said gravitational separation and said flotation.

9. The method of claim 8, wherein said processing comprises adding a coagulant to said process water in connection with said clarifier.

10. The method of claim 8, wherein said processing comprises adding a flocculent to said process water in connection with said clarifier.

11. The method of claim 8, wherein said processing comprises adding an oxidizer to said process water in connection with said clarifier.

12. The method of claim 8, wherein said processing comprises employing dissolved air flotation in connection with said clarifier.

13. The method of claim 1, wherein said clarifier is operative for removing particles from said process water via a first process of gravitational separation and a second process of flotation.

14. The method of claim 13, further comprising employing a skimmer in connection with said clarifier to remove a product removed from said process water via said second process of flotation.

15.-19. (canceled)

20. A system for use in connection with treating process water in and oil and gas industry application, comprising:
a clarifier, disposed in a flow path of said process water, said clarifier including at least one inclined plate having a top end, a bottom end, and first and second side ends;
said clarifier being disposed such that a first axis of said at least one plate is inclined at an angle relative to horizontal;
wherein said process water flows across said at least one plate along a second axis transverse to said first axis.

21. The system of claim 20, wherein said second axis extends across said at least one plate between said first and second sides thereof.

22. The system of claim 20, wherein said first axis extends across said plate between said top end and said bottom end thereof.

23. The system of claim 20, wherein said flow path is a supply path for supplying said process water to a pump system for use in a fracking operation.

24. The system of claim 23, wherein said flow path is configured for recirculating said process water recovered from a subterranean formation for reuse in said fracking operation.

25. The system of claim 24, wherein said clarifier is interposed between a recovery port, for recovering said process water from said subterranean formation and an injection port for injecting said process water into said subterranean formation.

26. The system of claim 20, wherein said clarifier is operative for removing particles from said process water via a process of at least one of gravitational separation in and flotation.

27. The system of claim 26, further a processing unit for processing said water to accelerate said one of said gravitational separation and said flotation.

28. The system of claim 27, wherein said processing unit is operative for adding a coagulant to said process water in connection with said clarifier.

29. The system of claim 27, wherein said processing unit is operative for adding a flocculent to said process water in connection with said clarifier.

30. The system of claim 27, wherein said processing unit is operative for adding an oxidizer to said process water in connection with said clarifier.

31. The method of claim 27, wherein said processing unit is operative for employing dissolved air flotation in connection with said clarifier.

32. The system of claim 20, wherein said clarifier is operative for removing particles from said process water via a first process of gravitational separation and a second process of flotation.

33. The system of claim 32, further comprising a skimmer operatively assoicated with said clarifier to remove a product removed from said process water via said second process of flotation.

34.-41. (canceled)
